(19) United States
(12) Patent Application Publication
(10) Pub. No.: US 2026/0228128 A1
(43) Pub. Date: Aug. 6, 2026

(54) CXL MEMORY MODULE, MEMORY PROCESSING METHOD, AND COMPUTER SYSTEM

(71) Applicant: BEIJING SUPERSTRING ACADEMY OF MEMORY TECHNOLOGY, Beijing (CN)

(72) Inventor: Jin Dai, Beijing (CN)

(73) Assignee: BEIJING SUPERSTRING ACADEMY OF MEMORY TECHNOLOGY, Beijing (CN)

(21) Appl. No.: 19/147,810

(22) PCT Filed: Jun. 1, 2023
(86) PCT No.: PCT/CN2023/097842

§ 371 Date: Jul. 14, 2025

(30) Foreign Application Priority Data
Feb. 8, 2023 (CN) 202310080907.2

(51) Int. Cl. G06F 12/02; G06F 13/16; G06F 13/42

(52) U.S. Cl. CPC G06F 12/0292; G06F 13/1668; G06F 13/4234; G06F 2212/7201

(57) ABSTRACT

A CXL memory module, a memory processing method, and a computer system. A controller chip is configured to execute the following operations: establishing a logical-physical address translation table; receiving an operation instruction based on a logical address, translating the logical address into a physical address of a DRAM chip on the basis of the logical-physical address translation table, and performing operation according to the physical address; receiving a memory application instruction through a CXL interface, the memory application instruction carrying size information of a memory; and performing memory allocation according to the size information of the memory, and returning a memory address allocated for a main body to the main body.

### CROSS-REFERENCES TO RELATED APPLICATIONS

The present application is a U.S. National Phase Entry of International PCT Application No. PCT/CN 2023/097842 having an international filing date of Jun. 1, 2023, which claims priority to Chinese Patent Application No. 202310080907.2, filed to the CNIPA on Feb. 8, 2023 and entitled “CXL Memory Module, Memory Processing Method, and Computer System”, the contents of which are incorporated herein by reference.

### TECHNICAL FIELD

The present disclosure relates to, but is not limited to, the field of storage, in particular to a CXL memory module, a memory processing method, and a computer system.

### BACKGROUND

CXL is a memory interface protocol based on the PCIe physical layer. The CXL protocol enables memory expansion of computers with CXL memory modules. A CXL memory module may be shared by multiple CPU chips or even multiple computing nodes.

At present, the CXL memory module passively performs read and write operations according to a physical address, which is not intelligent enough. And for any computing system, memory allocation is an important task. At a software level, this is done through a malloc( ) function or free( ) function. These functions are computationally intensive and often take up a lot of CPU computing time. When multiple CPU chips share a same CXL memory module, the memory allocation will be more complicated.

### SUMMARY

The following is a summary of subject matters described herein in detail. This summary is not intended to limit the scope of protection of the claims.

An embodiment of the present disclosure provides a CXL memory module, including a controller chip and at least one set of DRAM chips, wherein the controller chip has a CXL interface, and the CXL memory module performs at least one of operations:

the CXL memory module running a virtual memory; and the CXL memory module performing memory allocation.

An embodiment of the present disclosure also provides a method for processing a memory, applied to a CXL memory module provided with a controller chip and at least one set of DRAM chips, wherein the controller chip has a CXL interface, and the method includes at least one of:

running a virtual memory; and performing memory allocation.

An embodiment of the present disclosure further provides a controller chip of a CXL memory module, including a memory interface, a CXL interface, and a storage controller coupled to the memory interface and the CXL interface, wherein the storage controller is configured to perform the method for processing the memory according to any of the embodiments.

An embodiment of the present disclosure further provides a computer system, including a main body, and the CXL memory module according to any of the embodiments, wherein the main body is connected with the CXL memory module through a CXL interface.

The main body is capable of sending a memory read instruction or a memory write instruction to the CXL memory module through a cxl.mem protocol; and the main body is capable of sending a request memory instruction or a release memory instruction to the CXL memory module through a cxl.io protocol.

Compared with the prior art, the CXL memory module, the method for processing the memory, and the computer system according to at least one embodiment of the present disclosure have the following beneficial effects: the CXL memory module can run a virtual memory, a logical addresses is mapped to different physical addresses through a mapping table, which may improve security of a system, and the CXL memory module is more intelligent than a current CXL memory module that passively reads and writes according to a physical address; and the CXL memory module has a memory allocation function, and can accept and process a memory allocation instruction, and the CXL memory module with the memory allocation function can effectively share computing a load of a host.

Other aspects may be understood upon reading and understanding the drawings and detailed description.

### BRIEF DESCRIPTION OF DRAWINGS

Accompanying drawings are used for providing understanding of technical solutions of the present disclosure, and form a part of the specification. They are used for explaining the technical solutions of the present disclosure together with the embodiments of the present disclosure, but do not form a limitation on the technical solutions of the present disclosure.

FIG. 1 is a block diagram of a structure of a CXL memory module according to an exemplary embodiment of the present disclosure.

FIG. 2 is a block diagram of a structure of a CXL memory module according to another exemplary embodiment of the present disclosure.

FIG. 3 is a block diagram of a structure of a CXL memory module according to another exemplary embodiment of the present disclosure.

FIG. 4 is a flowchart of a method for processing a memory according to an exemplary embodiment of the present disclosure.

FIG. 5 is a flowchart of a method for processing a memory according to another exemplary embodiment of the present disclosure.

FIG. 6 is a block diagram of a structure of a controller chip of a CXL memory module according to an exemplary embodiment of the present disclosure.

FIG. 7 is a block diagram of a structure of a computer system according to an exemplary embodiment of the present disclosure.

FIG. 8 is a block diagram of a structure of a computer system according to another exemplary embodiment of the present disclosure.

### DETAILED DESCRIPTION

Embodiments of the present disclosure will be described in detail with reference to the accompanying drawings. The embodiments in the present disclosure and features in the embodiments may be combined with each other arbitrarily if there is no conflict.

Multiple embodiments are described herein, but the description is exemplary rather than restrictive, and to those of ordinary skills in the art, there may be more embodiments and implementation solutions within a scope contained in the embodiments described herein. Although many possible combinations of features are shown in the accompanying drawings and discussed in specific implementations, many other combinations of the disclosed features are also possible. Unless expressly limited, any feature or element of any embodiment may be used in combination with, or may replace, any other feature or element in any other embodiment.

The present disclosure includes and contemplates combinations with features and elements known to those of ordinary skills in the art. The disclosed embodiments, features and elements of the present disclosure may also be combined with any conventional features or elements to form the solutions defined by the claims. Any feature or element of any embodiment may also be combined with features or elements from other disclosed solutions to form another solution defined by the claims. Accordingly, it should be understood that any of the features shown and discussed in the present disclosure may be implemented alone or in any suitable combination. Therefore, the embodiments are not limited except the limitation by the appended claims and equivalents thereof. Moreover, various modifications and variations may be made within the protection scope of the appended claims.

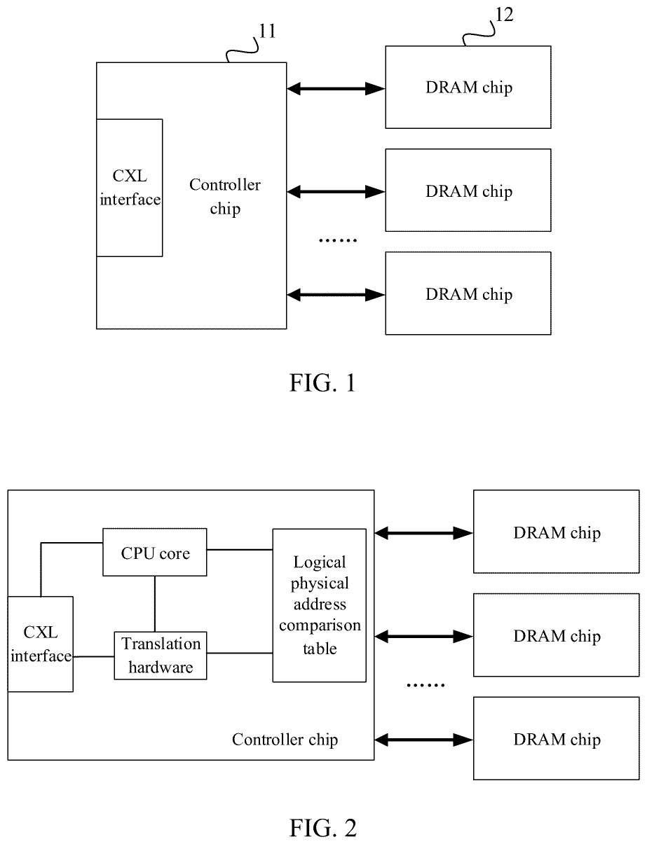

Moreover, when representative embodiments are described, the specification may have presented a method and a process as a particular order of acts. However, to an extent that the method or process does not depend on a specific order of the acts in present disclosure, the method or process should not be limited to the acts in the specific order. As will be understood by those of ordinary skills in the art, other orders of acts may also be possible. Therefore, the specific order of the acts illustrated in the specification should not be interpreted as a limitation on claims. In addition, the claims with respect to the method and process should not be limited to executing their acts according to the written order. Those skilled in the art may easily understand that these orders may change, and are still in the spirit and scope of the embodiments of the disclosure.
FIG. 1 is a block diagram of a structure of a CXL memory module according to an exemplary embodiment of the present disclosure, and FIG. 2 is a block diagram of a structure of a CXL memory module according to another exemplary embodiment of the present disclosure. As shown in FIG. 1 and FIG. 2, the CXL memory module may include a controller chip 11 and at least one set of DRAM chips 12, the controller chip has a CXL interface, and the CXL memory module performs at least one of the following operations: the CXL memory module running a virtual memory; and the CXL memory module performing memory allocation.

In an embodiment of the present disclosure, a CXL memory module is provided, which may run a virtual memory. And/or, the CXL memory module has a memory allocation function, and the CXL memory module is capable of receiving and processing a memory allocation instruction.

In an exemplary embodiment of the present disclosure, the CXL memory module runs the virtual memory, and the controller chip is configured to perform the following operations:

establishing a logical physical address translation table; and

receiving an operation instruction based on a logical address, translating the logical address into a physical address of a DRAM chip based on the logical physical address translation table, and performing an operation according to the physical address.

In an embodiment of the present disclosure, a CXL memory module with a virtual memory is provided, which can run the virtual memory. The CXL memory module runs the virtual memory, which may be achieved through the controller chip in the CXL memory module. The controller chip may have a built-in logical physical address translation table, and a logical address is mapped to different physical addresses through one mapping table, which may improve security of a system. Compared with a current CXL memory module that passively reads and writes according to a physical address, it is more intelligent.

The CXL memory module with the virtual memory have the following advantages.

When there is a bad block in a memory chip, it may be changed to other addresses through the virtual memory, which may improve a yield of the memory chip and reduce a cost.

When the memory allocation is fragmented and a main body needs consecutive memory space, several non-consecutive spaces may be mapped into a large block of consecutive addresses through the virtual memory.

When multiple main bodies share one CXL memory module, security can be better ensured through the virtual memory.

In an exemplary embodiment of the present disclosure, the main body may include a main CPU (which may be referred to as a CPU chip), a host, or a computing node. The main CPU may be a CPU chip having a host function, for example, the main CPU may be a CPU chip provided in the host. The host may be a host of a personal computer or a host of a cloud. The computing node may be a computing node configured in a computer system, and may send a data read and write request to the CXL memory module.

In an exemplary embodiment of the present disclosure, the operation instruction may include a memory read instruction and a memory write instruction, and the two operation instructions may be collectively referred to as read and write instructions. A CXL standard defines several transport layer protocols, among which a CXL configuration protocol (cxl.io protocol) may be used to transmit configuration and instruction information, and a CXL storage protocol (cxl.mem protocol) may support common memory reading and writing. CXL memory module may support the cxl.io protocol and the cxl.mem protocol. A main body connected to the CXL interface can send an operation instruction (such as the memory read instruction or the memory write instruction) to CXL memory module through cxl.mem protocol. The CXL memory module runs the virtual memory. Specifically, a logical physical address translation table may be established through the controller chip in CXL memory module, an operation instruction based on a logical address is received, the logical address is translated into a physical address of the DRAM chip based on the logical physical address translation table, and an operation (such as reading and writing) is performed according to the physical address.

In an exemplary embodiment of the present disclosure, the CXL memory module supports reading by a plurality of main bodies, and the controller chip establishes one logical physical address comparison table for each main body.

The controller chip receiving the operation instruction based on the logical address, translating the logical address into the physical address of the DRAM chip based on the logical physical address translation table, and performing the operation according to the physical address may include: when receiving the operation instruction based on the logical address, finding a logical physical address comparison table corresponding to a main body according to a main body identification in the operation instruction, translating the logical address into the physical address of the DRAM chip according to the found logical physical address comparison table, and performing the operation on the DRAM chip according to the physical address.

CXL memory module may be shared by multiple main bodies, which may simplify design of system software and improve security. When a plurality of main bodies share one CXL memory module, the shared CXL memory module may set one logical physical address comparison table for each main body, and the logical physical address comparison table stores a corresponding relationship between a logical address and a physical address of each main body, which may ensure that each main body uses a same logical address without conflicting physical addresses.

The controller chip may determine a main body according to a main body identification carried by each operation instruction, and determine a corresponding logical physical address comparison table for each main body.

When multiple main bodies share a CXL memory module, and each main body sends an operation instruction (such as a memory read instruction or a memory write instruction) to the CXL memory module through the cxl.mem protocol, the operation instruction includes a main body identification (ID), and the main body identification may include a port number or a source address of the main body. The CXL memory module may select a corresponding logical physical address comparison table for translation according to the main body identification.

The CXL protocol supports a variety of routing protocols. When a CXL memory module is shared and becomes FAM or G-FAM (a memory module connected to a network), and PBR (port-based routing) type needs to be used, the main body needs to send its own port number, the port number sent by the main body may be served as the main body identification. The main body may send a memory read instruction or a memory write instruction to the CXL memory module through the cxl.mem protocol, and the CXL memory module may read out corresponding data from the DRAM chip according to the received memory read instruction, or the CXL memory module may write the corresponding data into the DRAM chip according to the received memory write instruction.

In an exemplary embodiment of the present disclosure, the controller chip receiving the operation instruction based on the logical address, translating the logical address into the physical address of the DRAM chip based on the logical physical address translation table, and performing the operation according to the physical address may include:

receiving a memory read instruction sent by a main body through a cxl.mem protocol, and the memory read instruction carries a target logical address of data to be read; translating the target logical address into a target physical address of the DRAM chip based on the logical physical address translation table; and reading out corresponding data from the DRAM chip according to the target physical address and returning the corresponding data to the main body. The main body sends a memory read instruction (or may be referred to as a memory read request) to the CXL memory module through the cxl.mem protocol. The memory read instruction may include a target address of data to be read. The CXL memory module understands the target address as a logical address, looks up the logical physical address comparison table, and translates the logical address into a physical address. The CXL memory module reads data from the DRAM chip according to the physical address, and returns data read from the DRAM chip to the main body.

In an exemplary embodiment of the present disclosure, the controller chip receiving the operation instruction based on the logical address, translating the logical address into the physical address of the DRAM chip based on the logical physical address translation table, and performing the operation according to the physical address may include:

receiving a memory write instruction sent by a main body through a cxl.mem protocol, wherein the memory write instruction carries a target logical address for storing data to be written; translating the target logical address into a target physical address of the DRAM chip based on a logical physical address comparison table; and writing the data to be written into a corresponding physical address of the DRAM chip according to the target physical address.

The main body sends a memory write instruction (or may be referred to as a memory write request) to the CXL memory module through the cxl.mem protocol, and the memory write instruction includes a target address of data to be written. The CXL memory module understands the target address as a logical address, looks up the logical physical address comparison table, and translates the logical address into a physical address. The CXL memory module writes data to the DRAM chip according to the physical address, and writes the data sent by the main body into the corresponding physical address.

In an exemplary embodiment of the present disclosure, the CXL memory module may be provided with an embedded Static Random-Access Memory (SRAM for short) for storing a logical physical address comparison table.

In an exemplary embodiment of the present disclosure, an SRAM may be provided in the controller chip of the CXL memory module for storing a logical physical address comparison table. If the logical physical address comparison table is too large, for example, space occupied by the logical physical address comparison table is greater than a set value, the logical physical address comparison table may be stored in set space of a DRAM in the CXL memory module, and only a recently commonly used logical physical address comparison table is placed in the SRAM in the controller chip.

In an exemplary embodiment of the present disclosure, the controller chip may be provided with dedicated translation hardware, for example, address translation may be achieved through a Content Addressable Memory (CAM for short). An implementation principle of implementing address translation by CAM is the same as that of the existing method, which is not limited and described in the present embodiment.

In an exemplary embodiment of the present disclosure, the main body connected to the CXL interface can send a request memory instruction or a release memory instruction to the CXL memory module through the cxl.io protocol. The CXL memory module further performs memory allocation, and the controller chip is further configured to perform the following operations:

receiving a request memory instruction sent by the main body through the CXL interface, and the request memory instruction carries size information of a memory to be requested (i.e., size information of the memory to be requested); performing memory allocation according to the size information of the memory, and returning a logical address of a memory allocated for the main body to the main body.

In a case that the CXL module runs the virtual memory, after receiving the request memory instruction, a memory will be allocated and a corresponding logical address will be returned. The CXL memory module runs a virtual memory, and a logical address of the memory is returned to a corresponding main body. When there is a bad block in a memory chip, it may be changed to other addresses through the virtual memory, which may improve a yield of the memory chip and reduce a cost.

In an exemplary embodiment of the present disclosure, the controller chip performing memory allocation according to the size information of the memory, and returning the logical address of the memory allocated for the main body to the main body may include:

allocating a plurality of non-consecutive memory pages to the main body according to the size information of the memory, physical addresses of the plurality of allocated memory pages corresponding to a section of consecutive logical addresses, and returning the logical addresses to the main body.

In a case that the CXL module runs the virtual memory, after receiving the request memory instruction, a memory will be allocated and a corresponding logical address will be returned. And physical addresses of the plurality of fragmented memory pages may correspond to a section of consecutive logical addresses and the logical addresses may be returned to the main body. When the memory allocation is fragmented and a main body needs consecutive memory space, several non-consecutive spaces may be mapped to a large block of consecutive addresses through the virtual memory.

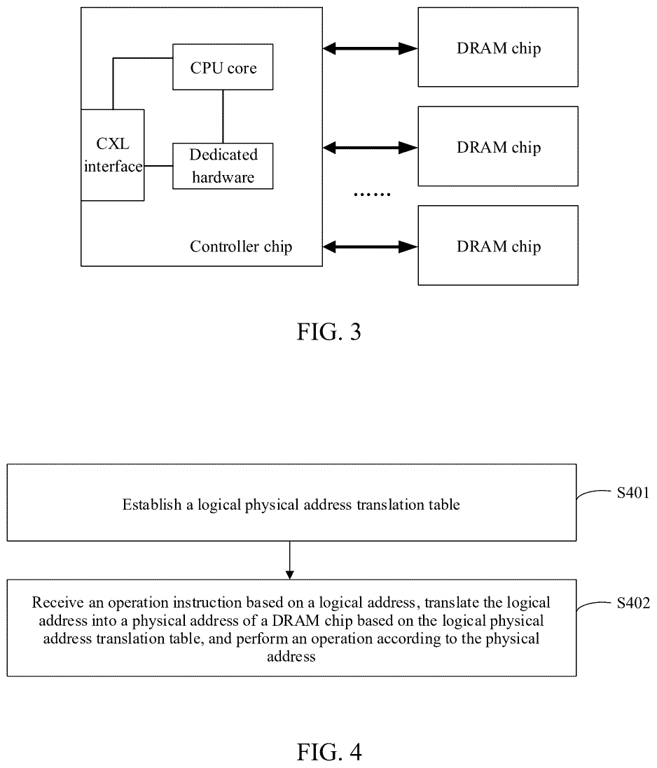

In an exemplary embodiment of the present disclosure, the main body connected to the CXL interface can send a request memory instruction or a release memory instruction to the CXL memory module through the cxl.io protocol. FIG. 3 is a block diagram of a structure of a CXL memory module according to another exemplary embodiment of the present disclosure. As shown in FIG. 3, the CXL memory module performs memory allocation, and a controller chip may be configured to perform the following operations:

receiving a request memory instruction through a CXL interface, wherein the request memory instruction carries size information of a memory; performing memory allocation according to the size information of the memory, and returning a address of a memory allocated for a main body to the main body.

The CXL memory module according to the embodiment of the present disclosure has a memory allocation function and can receive and process a memory allocation instruction. The CXL memory module with memory allocation function can effectively share a computing load of a main body.

When the main body needs to apply for memory space, a malloc instruction is sent through the cxl.io protocol, and the malloc instruction may include a requested memory size. After receiving the malloc instruction, the CXL memory module performs memory allocation, and returns an allocated starting address to the main body through the cxl.io protocol.

In an exemplary embodiment of the present disclosure, the controller chip may be further configured to perform the following operations:

receiving a release memory instruction through the CXL interface, wherein the release memory instruction carries a starting address of a released address block; performing memory release according to the starting address of the address block to be released carried in the release memory instruction, and releasing memory data corresponding to the address block.

The CXL memory module according to the embodiment of the present disclosure has a memory release function and can accept and process a release memory instruction. The CXL memory module with memory release function can effectively share a computing load of a main body.

When the main body needs to release memory space, a free instruction is sent through the cxl.io protocol, and the free instruction may include a starting address of a released address block. After receiving the free instruction, the CXL memory module releases perform memory release and releases a memory of a corresponding address block.

Existing solutions may be adopted for specific implementation methods of memory allocation and memory release, which is not limited and described in this embodiment.

In an exemplary embodiment of the present disclosure, the CXL memory module is shared by a plurality of main bodies; the request memory instruction received by the controller chip also carries a main body identification, and the controller chip returns a memory address allocated for the main body to the main body according to the main body identification.

There may be one or more main bodies connected to the CXL memory module, and when there are a plurality of main bodies connected to the CXL memory module, the plurality of main bodies may share one CXL memory module. The main body may include a main CPU (which may be referred to as a CPU chip), a host or a computing node. When multiple main bodies share one CXL memory module, a design of system software may be simplified and security can be improved.

The main CPU may be a CPU chip having a host function, for example, the main CPU may be a CPU chip provided in the host. The host may be a host of a personal computer or a host of a cloud. The computing node may be a computing node configured in a computer system, and may send a data read and write request to the CXL memory module.

When multiple main bodies share one CXL memory module and multiple main bodies need to apply for memory space, each main body may send a malloc instruction through the cxl.io protocol respectively, and the malloc instruction may include a requested memory size. After receiving the malloc instruction sent by any main body, the CXL memory module performs memory allocation, allocates a corresponding memory address to the main body, and returns the memory address allocated for the main body to the main body according to a main body identification.

In an exemplary embodiment of the present disclosure, the main body identification may include a port number or a source address of the main body.

In a case that multiple main bodies share a CXL memory module, when each main body sends a memory allocation instruction or a release memory instruction to the CXL memory module through the cxl.io protocol, the instruction includes a main body identification (ID), the main body identification may include a port number or source address of the main body. The CXL memory module may determine the main body according to the main body identification, and return a memory address allocated for the main body to the main body.

The CXL protocol supports a variety of routing protocols. When a CXL memory module is shared and becomes FAM or G-FAM (a memory module connected to a network), and PBR (port-based routing) type needs to be used, the main body needs to send its own port number, the port number sent by the main body may be served as the main body identification.

An embodiment of the present disclosure also provides a method for processing a memory, which is applied to a CXL memory module provided with a controller chip and at least one set of DRAM chips, wherein the controller chip has a CXL interface. The method for processing the memory may include at least one of: running a virtual memory; and performing memory allocation.

FIG. 4 is a flowchart of a method for processing a memory according to an exemplary embodiment of the present disclosure. As shown in FIG. 4, the CXL memory module can run mode virtual memory management, and running the virtual memory may include S401-S402.

S401: a logical physical address translation table is established.

S402: an operation instruction based on a logical address is received, the logical address is translated into a physical address of a DRAM chip based on the logical physical address translation table, and an operation according to the physical address is performed.

In an embodiment of the present disclosure, a CXL memory module with a virtual memory is provided, which can run the virtual memory. The CXL memory module runs the virtual memory, which may be achieved through the controller chip in the CXL memory module. The controller chip may have a built-in logical physical address translation table, and a logical address is mapped to different physical addresses through one mapping table, which may improve security of a system. Compared with a current CXL memory module that passively reads and writes according to a physical address, it is more intelligent.

An execution main body of the method for processing the memory provided by the embodiment of the present disclosure is the CXL memory module shown in FIG. 2, and its implementation principle and implementation effect are similar, which is not repeated herein.

In an exemplary embodiment of the present disclosure, the CXL memory module supports reading by a plurality of main bodies, and the controller chip establishes one logical physical address comparison table for each main body.

Receiving the operation instruction based on the logical address, translating the logical address into the physical address of the DRAM chip based on the logical physical address translation table, and performing the operation according to the physical address may include: when receiving the operation instruction based on the logical address, finding a logical physical address comparison table corresponding to a main body according to a main body identification in the operation instruction, translating the logical address into the physical address of the DRAM chip according to the found logical physical address comparison table, and performing the operation on the DRAM chip according to the physical address.

In an exemplary embodiment of the present disclosure, the main body may include a main CPU, a host, or a computing node.

In an exemplary embodiment of the present disclosure, the main body identification may include a port number or a source address of the main body.

In an exemplary embodiment of the present disclosure, receiving the operation instruction based on the logical address, translating the logical address into the physical address of the DRAM chip based on the logical physical address translation table, and performing the operation according to the physical address may include:

receiving a memory read instruction sent by a main body through a cxl.mem protocol, and the memory read instruction carries a target logical address of data to be read; translating the target logical address into a target physical address of the DRAM chip based on the logical physical address translation table; and reading out corresponding data from the DRAM chip according to the target physical address and returning the corresponding data to the main body.

In an exemplary embodiment of the present disclosure, receiving the operation instruction based on the logical address, translating the logical address into the physical address of the DRAM chip based on the logical physical address translation table, and performing the operation according to the physical address may include:

receiving a memory write instruction sent by a main body through a cxl.mem protocol, wherein the memory write instruction carries a target logical address for storing data to be written; translating the target logical address into a target physical address of the DRAM chip based on a logical physical address comparison table; and writing the data to be written into a corresponding physical address of the DRAM chip according to the target physical address.

In an exemplary embodiment of the present disclosure, the CXL memory module further performs memory allocation, and the controller chip is further configured to perform the following operations:

receiving a request memory instruction sent by a main body through a CXL interface, and the request memory instruction carries size information of a memory; performing memory allocation according to the size information of the memory, and returning a logical address of a memory allocated for a main body to the main body.

In an exemplary embodiment of the present disclosure, the controller chip performing memory allocation according to the size information of the memory, and returning the logical address of the memory allocated for the main body to the main body may include:

allocating a plurality of non-consecutive memory pages to the main body according to the size information of the memory, physical addresses of the plurality of allocated memory pages corresponding to a section of consecutive logical addresses, and returning the logical addresses to the main body.

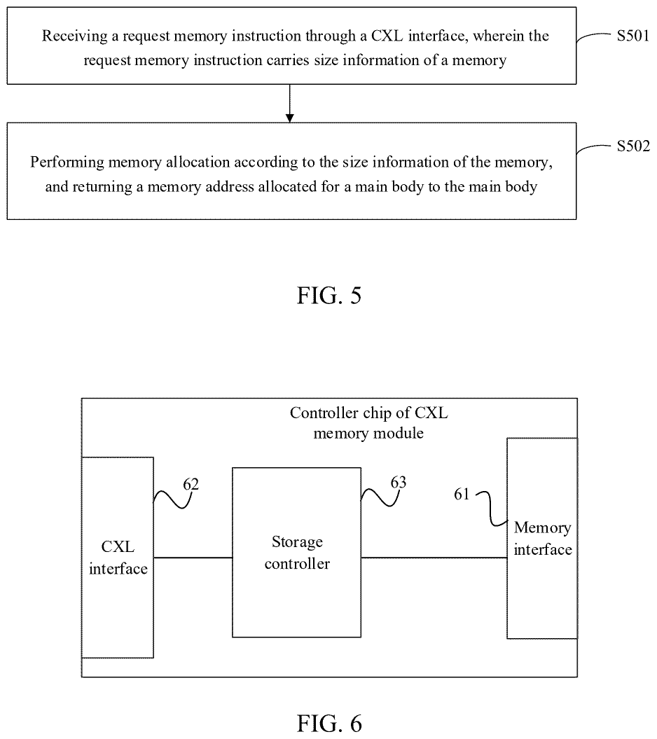

FIG. 5 is a flowchart of a method for processing a memory according to another exemplary embodiment of the present disclosure. As shown in FIG. 5, the CXL memory module can perform memory allocation, and performing the memory allocation may include S501-S502.

S501: A request memory instruction is received through a CXL interface, and the request memory instruction carries size information of a memory.

S502: Memory allocation is performed according to the size information of the memory, and a memory address allocated for a main body is returned to the main body.

The CXL memory module according to the embodiment of the present disclosure has a memory allocation function and can receive and process a memory allocation instruction. The CXL memory module with memory allocation function can effectively share a computing load of a main body.

When the main body needs to apply for memory space, a malloc instruction is sent through the cxl.io protocol, and the malloc instruction may include a requested memory size. After receiving the malloc instruction, the CXL memory module performs memory allocation, and returns an allocated starting address to the main body through the cxl.io protocol.

An execution main body of the method for processing the memory provided by the embodiment of the present disclosure is the CXL memory module shown in FIG. 3, and its implementation principle and implementation effect are similar, which is not repeated herein.

In an exemplary embodiment of the present disclosure, the CXL memory module may be shared by a plurality of main bodies; the received request memory instruction also carries a main body identification, and returning the memory address allocated for the main body to the main body may include returning the memory address allocated for the main body to the main body according to the main body identification.

In an exemplary embodiment of the present disclosure, the main body may include a main CPU, a host, or a computing node.

In an exemplary embodiment of the present disclosure, the main body identification may include a port number or a source address of the main body.

In an exemplary embodiment of the present disclosure, the memory allocation method may further include:

receiving a release memory instruction through the CXL interface, wherein the release memory instruction carries a starting address of a released address block; performing memory release according to the starting address, and releasing memory data corresponding to the address block.

FIG. 6 is a block diagram of a structure of a controller chip of a CXL memory module according to an exemplary embodiment of the present disclosure. As shown in FIG. 6, the controller chip may include a memory interface 61, a CXL interface 62, and a storage controller 63 coupled to the memory interface and the CXL interface.

A main body connected to the CXL interface can send a request memory instruction or a release memory instruction to the CXL memory module through a cxl.io protocol, and the main body connected to the CXL interface can send a memory read instruction or a memory write instruction to the CXL memory module through a cxl.mem protocol. The memory controller is configured to perform the method for storing a memory shown in any of embodiments and the method for allocating a memory shown in any of the embodiments.

In an exemplary embodiment of the present disclosure, as shown in FIG. 2, one embodiment of the controller chip may be implemented by an embedded CPU core and dedicated hardware such as translation hardware. The embedded CPU core may be configured to perform the method for storing the memory shown in any of the embodiments, and the translation hardware may implement address translation through Content Addressable Memory (CAM for short).

In an exemplary embodiment of the present disclosure, an SRAM may be provided in the controller chip of the CXL memory module for storing a logical physical address comparison table. If the logical physical address comparison table is too large, for example, space occupied by the logical physical address comparison table is greater than a set value, the logical physical address comparison table may be stored in set space of a DRAM in the CXL memory module, and only a recently commonly used logical physical address comparison table is placed in the SRAM in the controller chip.

In an exemplary embodiment of the present disclosure, as shown in FIG. 3, one embodiment of the controller chip may be implemented by an embedded CPU core and dedicated hardware (dedicated memory allocation acceleration hardware) together. The embedded CPU core may be configured to perform the memory allocation method shown in any of the embodiments, and the translation hardware may accelerate the memory allocation through the memory allocation acceleration hardware.

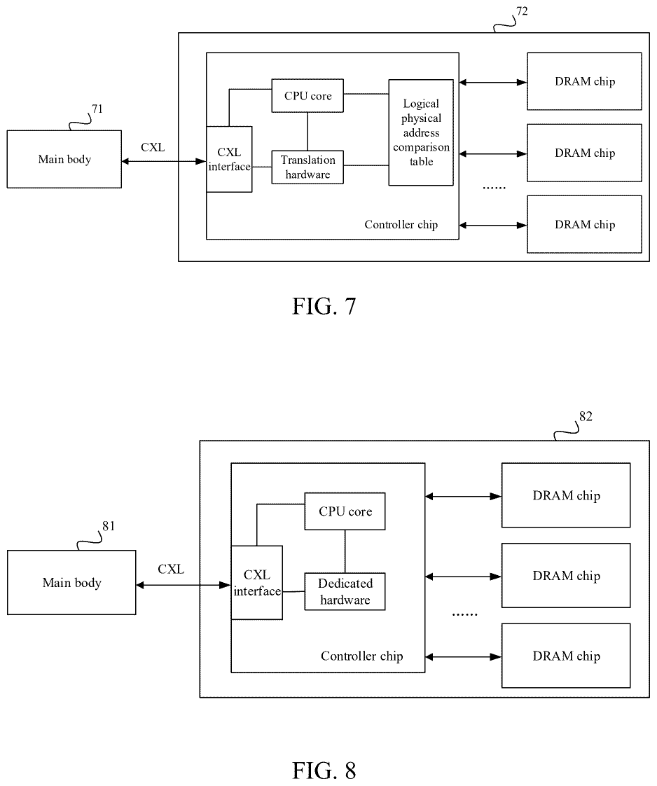

FIG. 7 is a block diagram of a structure of a computer system according to an exemplary embodiment of the present disclosure. As shown in FIG. 7, the computer system may include a main body 71 and a CXL memory module 72 shown in any of the embodiments. The main body is connected with the CXL memory module through a CXL interface.

The main body can send a memory read instruction or a memory write instruction to the CXL memory module through a cxl.mem protocol.

The main body may be connected with the CXL memory module through different CXL interfaces, and the main body may send an operation instruction (such as the memory read instruction or the memory write instruction) to the CXL memory module. The CXL memory module can run the virtual memory, which may be achieved through the controller chip in the CXL memory module. The controller chip may have a built-in logical physical address translation table, and a logical address is mapped to different physical addresses through one mapping table, which may improve security of a system. Compared with a current CXL memory module that passively reads and writes according to a physical address, it is more intelligent.

In an exemplary embodiment of the present disclosure, there are one or more main bodies connected to the CXL memory module, and when there are a plurality of main bodies connected to the CXL memory module, the plurality of main bodies may share one CXL memory module. When multiple main bodies share one CXL memory module, security can be better ensured.

FIG. 8 is a block diagram of a structure of a computer system according to another exemplary embodiment of the present disclosure. As shown in FIG. 8, the computer system may include a main body 81 and a CXL memory module 82 shown in any of the embodiments. The main body is connected with the CXL memory module through a CXL interface.

The main body can send a request memory instruction or a release memory instruction to the CXL memory module through a cxl.io protocol.

The main body may be connected with the CXL memory module through different CXL interfaces, and the main body may apply for memory space from the CXL memory module. The CXL memory module has a memory allocation function and can receive and process a memory allocation instruction. The CXL memory module with memory allocation function can effectively share a computing load of a main body.

When the main body needs to apply for memory space, a malloc instruction is sent through the cxl.io protocol, and the malloc instruction may include a requested memory size. After receiving the malloc instruction, the CXL memory module performs memory allocation, and returns an allocated starting address to the main body through the cxl.io protocol.

When the main body needs to release memory space, a free instruction is sent through the cxl.io protocol, and the free instruction may include a starting address of a released address block. After receiving the free instruction, the CXL memory module releases perform memory release and releases a memory of a corresponding address block.

In an exemplary embodiment of the present disclosure, there are one or more main bodies connected to the CXL memory module, and when there are a plurality of main bodies connected to the CXL memory module, the plurality of main bodies may share one CXL memory module. When multiple main bodies share one CXL memory module, security can be better ensured.

In an exemplary embodiment of the present disclosure, as shown in FIG. 7, the controller chip may be provided with dedicated hardware (such as dedicated memory allocation acceleration hardware) to accelerate memory allocation. The implementation principle of the dedicated memory allocation acceleration hardware is the same as that of the existing method, which is not limited and described in the present embodiment.

It may be understood by those of ordinary skills in the art that all or some acts in the above method, and function modules/units in the system and the apparatus in the disclosure may be implemented as software, firmware, hardware, or an appropriate combination thereof. In a hardware implementation, division of the function modules/units mentioned in the above description is not always corresponding to division of physical assemblies. For example, a physical assembly may have multiple functions, or a function or an act may be executed by several physical assemblies in cooperation. Some assemblies or all assemblies may be implemented as software executed by a processor such as a digital signal processor or a microprocessor, or implemented as hardware, or implemented as an integrated circuit such as an application specific integrated circuit. Such software may be distributed in a computer-readable medium, and the computer-readable medium may include a computer storage medium (or a non-transitory medium) and a communication medium (or a transitory medium). As known to those of ordinary skills in the art, a term computer storage medium includes volatile and nonvolatile, and removable and irremovable media implemented in any method or technology for storing information (for example, computer-readable instructions, a data structure, a program module, or other data). The computer storage medium includes, but is not limited to, RAM, ROM, EEPROM, a Flash RAM, or another memory technology, CD-ROM, a Digital Versatile Disk (DVD) or another optical disk storage, a magnetic box, a magnetic tape, magnetic disk storage or another magnetic storage apparatus, or any other medium that may be used for storing desired information and may be accessed by a computer. In addition, it is known to those of ordinary skills in the art that the communication medium usually includes computer-readable instructions, a data structure, a program module, or other data in a modulated data signal of, such as, a carrier or another transmission mechanism, and may include any information delivery medium.

1. A CXL memory module, comprising a controller chip and at least one set of DRAM chips, wherein the controller chip has a CXL interface, and the CXL memory module performs at least one of operations:
the CXL memory module running a virtual memory; and the CXL memory module performing memory allocation.

2. The CXL memory module according to claim 1, wherein the CXL memory module runs the virtual memory, and the controller chip is configured to perform following operations:
establishing a logical physical address translation table; and
receiving an operation instruction based on a logical address, translating the logical address into a physical address of a DRAM chip based on the logical physical address translation table, and performing an operation according to the physical address.

3. The CXL memory module according to claim 2, wherein the CXL memory module supports reading by a plurality of main bodies, and the controller chip establishes one logical physical address comparison table for each main body; and
the controller chip receiving the operation instruction based on the logical address, translating the logical address into the physical address of the DRAM chip based on the logical physical address translation table, and performing the operation according to the physical address comprises: when receiving the operation instruction based on the logical address, finding a logical physical address comparison table corresponding to a main body according to a main body identification in the operation instruction, translating the logical address into the physical address of the DRAM chip according to the found logical physical address comparison table, and performing the operation on the DRAM chip according to the physical address.

4. The CXL memory module according to claim 2, wherein the controller chip receiving the operation instruction based on the logical address, translating the logical address into the physical address of the DRAM chip based on the logical physical address translation table, and performing the operation according to the physical address comprises:
receiving a memory read instruction sent by a main body through a cxl.mem protocol, wherein the memory read instruction carries a target logical address of data to be read;
translating the target logical address into a target physical address of the DRAM chip based on the logical physical address translation table; and
reading out corresponding data from the DRAM chip according to the target physical address and returning the corresponding data to the main body.

5. The CXL memory module according to claim 2, wherein the controller chip receiving the operation instruction based on the logical address, translating the logical address into the physical address of the DRAM chip based on the logical physical address translation table, and performing the operation according to the physical address comprises:
receiving a memory write instruction sent by a main body through a cxl.mem protocol, wherein the memory write instruction carries a target logical address for storing data to be written;
translating the target logical address into a target physical address of the DRAM chip based on a logical physical address comparison table; and
writing the data to be written into a corresponding physical address of the DRAM chip according to the target physical address.

6. The CXL memory module according to claim 2, wherein the CXL memory module further performs memory allocation, and the controller chip is further configured to perform following operations:
receiving a request memory instruction sent by a main body through the CXL interface, wherein the request memory instruction carries size information of a memory; and
performing memory allocation according to the size information of the memory, and returning a logical address of a memory allocated for the main body to the main body.

7. The CXL memory module according to claim 6, wherein the controller chip performing the memory allocation according to the size information of the memory, and returning the logical address of the memory allocated for the main body to the main body comprises:
allocating a plurality of non-consecutive memory pages to the main body according to the size information of the memory, physical addresses of the plurality of allocated memory pages corresponding to a section of consecutive logical addresses, and returning the logical addresses to the main body.

8. The CXL memory module according to claim 1, wherein the CXL memory module performs memory allocation, and the controller chip is configured to perform following operations:
receiving a request memory instruction through the CXL interface, wherein the request memory instruction carries size information of a memory; and
perform memory allocation according to the size information of the memory, and return a memory address allocated for a main body to the main body.

9. The CXL memory module according to claim 8, wherein the CXL memory module is shared by a plurality of main bodies; and
the request memory instruction received by the controller chip further carries a main body identification, and the controller chip returns the memory address allocated for the main body to the main body according to the main body identification.

10. The CXL memory module according to claim 3, wherein the main body comprises a main CPU, a host, or a computing node.

11. The CXL memory module according to claim 3, wherein the main body identification comprises a port number or a source address of the main body.

12. The CXL memory module according to claim 8, wherein the controller chip is further configured to perform following operations:
receiving a release memory instruction through the CXL interface, wherein the release memory instruction carries a starting address of a released address block; and
performing memory release according to the starting address to release memory data corresponding to the address block.

13. A method for processing a memory, applied to a CXL memory module provided with a controller chip and at least one set of DRAM chips, wherein the controller chip has a CXL interface, and the method comprises at least one of:
running a virtual memory; and performing memory allocation.

14. The method according to claim 13, wherein the running the virtual memory comprises:
establishing a logical physical address translation table; and
receiving an operation instruction based on a logical address, translating the logical address into a physical address of a DRAM chip based on the logical physical address translation table, and performing an operation according to the physical address.

15. The method according to claim 14, wherein the CXL memory module supports reading by a plurality of main bodies, and the controller chip establishes one logical physical address comparison table for each main body; and
the receiving the operation instruction based on the logical address, translating the logical address into the physical address of the DRAM chip based on the logical physical address translation table, and performing the operation according to the physical address comprises: when receiving the operation instruction based on the logical address, finding a logical physical address comparison table corresponding to a main body according to a main body identification in the operation instruction, translating the logical address into the physical address of the DRAM chip according to the found logical physical address comparison table, and performing the operation on the DRAM chip according to the physical address.

16. The method according to claim 14, wherein the receiving the operation instruction based on the logical address, translating the logical address into the physical address of the DRAM chip based on the logical physical address translation table, and performing the operation according to the physical address comprises:
receiving a memory read instruction sent by a main body through a cxl.mem protocol, wherein the memory read instruction carries a target logical address of data to be read;
translating the target logical address into a target physical address of the DRAM chip based on the logical physical address translation table; and
reading out corresponding data from the DRAM chip according to the target physical address and returning the corresponding data to the main body.

17. The method according to claim 14, wherein the receiving the operation instruction based on the logical address, translating the logical address into the physical address of the DRAM chip based on the logical physical address translation table, and performing the operation according to the physical address comprises:
receiving a memory write instruction sent by a main body through a cxl.mem protocol, wherein the memory write instruction carries a target logical address for storing data to be written;
translating the target logical address into a target physical address of the DRAM chip based on a logical physical address comparison table; and
writing the data to be written into a corresponding physical address of the DRAM chip according to the target physical address.

18. The method according to claim 14, wherein the CXL memory module further performs memory allocation, and the controller chip is further configured to performing following operations:
receiving a request memory instruction sent by a main body through the CXL interface, wherein the request memory instruction carries size information of a memory; and
performing memory allocation according to the size information of the memory, and returning a logical address of a memory allocated for the main body to the main body.

19. (canceled)

20. The method according to claim 13, wherein the performing memory allocation comprises:
receiving a request memory instruction through the CXL interface, wherein the request memory instruction carries size information of a memory; and
performing memory allocation according to the size information of the memory, and returning a memory address allocated for a main body to the main body.

21. The method according to claim 20, wherein the CXL memory module is shared by a plurality of main bodies; the received request memory instruction further carries a main body identification, and the returning the memory address allocated for the main body to the main body comprises returning the memory address allocated for the main body to the main body according to the main body identification.

22-27. (canceled)
